(19) United States
(12) Patent Application Publication
(10) Pub. No.: US 2026/0110927 A1
(43) Pub. Date: Apr. 23, 2026

(54) OPTICAL WAVEGUIDING MEDIUM, OPTICAL MODULATION ELEMENT, AND MANUFACTURING METHOD OF OPTICAL MODULATION ELEMENT

(71) Applicant: TDK CORPORATION, Tokyo (JP)

(72) Inventors: Jiro YOSHINARI, Tokyo (JP); Shigeru Mieda, Tokyo (JP); Hiroki Hara, Tokyo (JP); Hideaki Fukuzawa, Tokyo (JP)

(73) Assignee: TDK CORPORATION, Tokyo (JP)

(21) Appl. No.: 19/358,634

(22) Filed: Oct. 15, 2025

(30) Foreign Application Priority Data
Oct. 21, 2024 (JP) 2024-185033

(51) Int. Cl. G02F 1/035

(52) U.S. Cl. CPC G02F 1/035

(57) ABSTRACT

An optical waveguide medium includes a substrate, ABX₃ type ferroelectric thin film formed on the substrate, first dielectric thin film formed on the ABX₃ type ferroelectric thin film, second dielectric thin film formed on the first dielectric thin film, and third dielectric thin film formed on the first dielectric thin film and second dielectric thin film. The first dielectric thin film, second dielectric thin film, and third dielectric thin film form a buried optical waveguide structure in which the second dielectric thin film is buried with the first dielectric thin film and third dielectric thin film. The refractive indexes of the first dielectric thin film and third dielectric thin film are lower than the refractive indexes of the ABX₃ type ferroelectric thin film and second dielectric thin film.

### TECHNICAL FIELD

The present invention relates to an optical waveguiding medium, an optical modulation element, and a manufacturing method of an optical modulation element, and particularly to an optical waveguiding medium, an optical modulation element, and a manufacturing method of an optical modulation element using ferroelectric ABX₃ crystal.

### BACKGROUND ART

Along with the spread of the Internet, the amount of communication has increased dramatically, and the importance of the optical fiber communication has become heightened. The optical fiber communication converts electrical signals to optical signals and transmits the optical signals through optical fibers, and is characterized by a wide bandwidth, low loss, and resistance to noise.

As methods for converting electrical signals to optical signals are known a direct modulation method using a semiconductor laser and an external modulation method using an optical modulator. The direct modulation method does not require any optical modulator and is low cost, but there are limitations to high-speed modulation, so that the external modulation method is used for high-speed, long-distance applications.

As an optical modulator, a Mach-Zehnder type optical modulator using ferroelectric ABX₃ crystals such as lithium niobate film (LiNbO₃) has been put to practical use (see, for example, Patent Document 1). A Mach-Zehnder type optical modulator uses an optical waveguide (Mach-Zehnder optical waveguide) with a Mach-Zehnder interferometer structure in which light emitted from one light source is split into two, passed through different paths, and then superimposed again to cause interference.

Patent Document 1 describes a ridge-type optical modulation element that is provided with a waveguide layer made of a lithium niobate film formed on a substrate, the waveguide layer having a slab portion with a predetermined thickness and a ridge portion protruding from the slab portion.

The ferroelectric ABX₃ crystals are excellent electro-optical materials with low-loss optical propagation characteristics, a large electro-optic coefficient, linear modulation response, and a large modulation bandwidth. However, most conventional optical modulation elements using ferroelectric ABX₃ crystals are manufactured using non-standard etching techniques or partially etched ridge waveguides, and lack the reproducibility of the waveguide shape as compared to silicon photonics optical modulation elements.

As an alternative to optical modulation elements using ridge waveguides, hybrid devices have been developed that combine a lithium niobate thin film with a waveguide made of silicon nitride (Si₃N₄) (see, for example, Patent Document 2).

The hybrid device disclosed in Patent Document 2 has a structure in which a substrate, on which a cladding layer with an embedded waveguide structure is laminated, and an electro-optic modulation layer containing a lithium niobate thin film are bonded together.

### CITATION LIST

### Patent Document

[Patent document 1] Japanese Patent No. 7,538,209
[Patent document 2] U.S. Pat. No. 10,788,689

### SUMMARY OF THE INVENTION

### Problems to be Solved by the Invention

However, the structure disclosed in Patent Document 2, in which a cladding layer and an electro-optic modulation layer are bonded together, is time-consuming to fabricate, making it difficult to mass-produce and expensive.

The present invention has been made to solve these conventional problems, and has an object to provide a hybrid-type optical waveguide medium, an optical modulation element, and a manufacturing method for an optical modulation element that are excellent in mass productivity and low cost.

### Means for Solving Problems

In order to solve the above problems, the optical waveguide medium according to the present invention comprises a substrate, an ABX₃ type ferroelectric thin film formed on the substrate, a first dielectric thin film formed on the ABX₃ type ferroelectric thin film, a second dielectric thin film formed on the first dielectric thin film, and a third dielectric thin film formed on the first dielectric thin film and the second dielectric thin film. The first dielectric thin film, the second dielectric thin film, and the third dielectric thin film form a buried optical waveguide structure in which the second dielectric thin film is buried with the first dielectric thin film and the third dielectric thin film. The refractive indexes of the first dielectric thin film and the third dielectric thin film are lower than the refractive indexes of the ABX₃ type ferroelectric thin film and the second dielectric thin film.

In order to solve the above problems, the optical modulation element according to the present invention comprises a substrate, an ABX₃ type ferroelectric thin film formed on the substrate, a first dielectric thin film formed on the ABX₃ type ferroelectric thin film, a second dielectric thin film formed on the first dielectric thin film, a third dielectric thin film formed on the first dielectric thin film and the second dielectric thin film, and a traveling wave electrode formed on the third dielectric thin film and consisting of a signal electrode and a ground electrode for applying an electric field to the ABX₃ type ferroelectric thin film. The first dielectric thin film, the second dielectric thin film, and the third dielectric thin film embed the second dielectric thin film with the first dielectric thin film and the third dielectric thin film, forming first and second embedded optical waveguide structures adjacent to each other. The refractive indexes of the first dielectric thin film and the third dielectric thin film are lower than the refractive indexes of the ABX₃ type ferroelectric thin film and the second dielectric thin film.

In order to solve the above problems, the method for manufacturing an optical modulation element according to the present invention includes a step of forming an ABX₃ type ferroelectric thin film on a substrate by sputtering, a step of forming a first dielectric thin film on the ABX₃ type ferroelectric thin film, a step of forming a second dielectric thin film on the first dielectric thin film, a step of forming a third dielectric thin film on the first and second dielectric thin films, and a step of forming a traveling wave electrode consisting of a signal electrode and a ground electrode on the third dielectric thin film for applying an electric field to the ABX₃ type ferroelectric thin film. The first dielectric thin film, the second dielectric thin film, and the third dielectric thin film embed the second dielectric thin film with the first dielectric thin film and the third dielectric thin film, forming first and second embedded optical waveguide structures adjacent to each other. The refractive indexes of the first dielectric thin film and the third dielectric thin film are lower than the refractive indexes of the ABX₃ type ferroelectric thin film and the second dielectric thin film.

### Effects of the Invention

The present invention provides a hybrid-type optical waveguide medium, an optical modulation element, and a manufacturing method for an optical modulation element that are excellent in mass productivity and low cost.

### BRIEF DESCRIPTION OF DRAWINGS

FIG. 1 is a schematic cross-sectional view of an optical waveguide medium according to a first embodiment of the present invention.

FIG. 2 is a schematic plan view of an optical modulation element according to a second embodiment of the present invention.

FIG. 3 is a cross-sectional view taken along line A-A in FIG. 2.

FIG. 4 is a diagram outlining the manufacturing process of an optical modulation element according to the second embodiment of the present invention.

FIG. 5 is a schematic plan view of an optical modulation element according to a third embodiment of the present invention.

FIG. 6 is a cross-sectional view taken along line B-B in FIG. 5.

FIG. 7 is a diagram outlining the manufacturing process of an optical modulation element according to the third embodiment of the present invention.

FIG. 8A is a diagram showing a simulation model of the optical waveguide medium of Example 1.

FIG. 8B is a diagram showing the electric field distribution of light in the optical waveguide medium of Example 1.

FIG. 9 is a diagram showing a simulation model of the optical modulation element of Example 2.

FIG. 10 is a graph showing the full width at half maximum of the optical intensity and the electric field efficiency when the thickness and width of the second dielectric thin film are changed in the optical modulation element of Example 3.

FIG. 11 is a graph showing the propagation loss and the electric field efficiency when the distance between the electrode and the ABX₃ type ferroelectric thin film is changed in the optical modulation element of Example 4.

FIG. 12 is a diagram showing a simulation model of the optical modulation element of Example 5.

FIG. 13A is a graph showing the full width at half maximum of the optical intensity when the width of the second dielectric thin film is changed in the optical modulation element of Example 5.

FIG. 13B is a graph showing the electric field efficiency when the material of the cladding layer and the width of the second dielectric thin film are changed in the optical modulation element of Example 5.

FIG. 14 is a graph showing the full width at half maximum of the optical intensity and the electric field efficiency when the thickness of the first dielectric thin film is changed in the optical modulation element of Example 6.

FIG. 15A is a diagram showing a simulation model of the optical modulation element of Example 7.

FIG. 15B is a graph showing the electric field efficiency when the width of the second dielectric thin film is changed in the optical modulation element of Example 7.

FIG. 16A is a diagram showing a simulation model of the optical modulation element of Example 8.

FIG. 16B is a graph showing the electric field efficiency when the distance between the signal electrode and the ground electrode is changed in the optical modulation element of Example 8.

FIG. 17A is a diagram showing a simulation model of the optical modulation element of Example 9.

FIG. 17B is a graph showing the electric field efficiency when the distance between the signal electrode and the ground electrode is changed in the optical modulation element of Example 9.

### DETAILED DESCRIPTION OF EMBODIMENTS

Hereinafter, the embodiments of the optical waveguide medium, optical modulation element, and manufacturing method of the optical modulation element according to the present invention will be described with reference to the drawings. It should be noted that the dimensional ratios of the components in each drawing do not necessarily match the actual dimensional ratios.

### First Embodiment

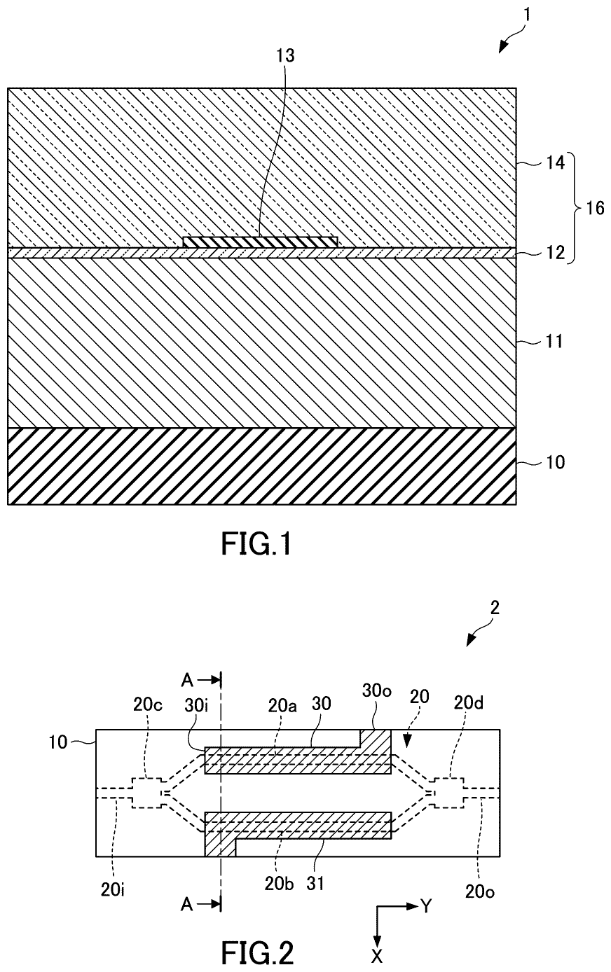

The optical waveguide medium of the first embodiment will be described hereinafter with reference to FIG. 1. The optical waveguide medium 1 of the first embodiment comprises a substrate 10, an ABX₃ type ferroelectric thin film 11, a first dielectric thin film 12, a second dielectric thin film 13, and a third dielectric thin film 14.

The ABX₃ type ferroelectric thin film 11 is a thin film of ferroelectric ABX₃ crystal, which is an electro-optical material, and is, for example, a c-axis oriented or a-axis oriented lithium niobate film or lithium tantalate film. The ABX₃ type ferroelectric thin film 11 is a sputtered thin film formed on the substrate 10 by a sputtering method.

By using a lithium niobate film or a lithium tantalate film as the ABX₃ type ferroelectric thin film 11, the optical waveguide medium 1 can exhibit an excellent electro-optical effect. Furthermore, since the ABX₃ type ferroelectric thin film 11 is a sputtered thin film, the optical waveguide medium 1 is excellent in mass productivity and cost reduction.

The first dielectric thin film 12 is formed on the ABX₃ type ferroelectric thin film 11. Furthermore, the third dielectric thin film 14 is formed on the first dielectric thin film 12 and the second dielectric thin film 13. The first dielectric thin film 12, the second dielectric thin film 13, and the third dielectric thin film 14 collectively constitute a buried optical waveguide structure in which the second dielectric thin film 13 is buried by the first dielectric thin film 12 and the third dielectric thin film 14.

The second dielectric thin film 13 is formed on the first dielectric thin film 12. The cross-sectional shape of the second dielectric thin film 13 may have any shape capable of guiding light, and may be, for example, a rectangle as shown in FIG. 1, or may be a square, trapezoid, or triangle. The second dielectric thin film 13 is made of, for example, silicon nitride (Si₃N₄), which has excellent optical guiding properties and workability.

The first dielectric thin film 12 and the third dielectric thin film 14 function as cladding layers that confine light in the second dielectric thin film 13 and the ABX₃ type ferroelectric thin film 11. For this reason, the refractive indexes of the first dielectric thin film 12 and the third dielectric thin film 14 are lower than the refractive indexes of the ABX₃ type ferroelectric thin film 11 and the second dielectric thin film 13. Hereinafter, the first dielectric thin film 12 and the third dielectric thin film 14 are collectively referred to as the cladding layer 16.

The first dielectric thin film 12 is preferably made of a highly transparent material such as, for example, aluminum oxide (Al₂O₃), silicon dioxide (SiO₂), LaAlO₃, LaYO₃, ZnO, HfO₂, MgO, or Y₂O₃ which are all usable. Similarly, the third dielectric thin film 14 may be made of Al₂O₃, SiO₂, LaAlO₃, LaYO₃, ZnO, HfO₂, MgO, or Y₂O₃ which are all usable. The first dielectric thin film 12 and the third dielectric thin film 14 may or may not be made of the same material.

The second dielectric thin film 13 and the ABX₃ type ferroelectric thin film 11 are optically coupled through the first dielectric thin film 12. The second dielectric thin film 13, the first dielectric thin film 12, and the ABX₃ type ferroelectric thin film 11 function as a three-dimensional optical waveguide. Since the second dielectric thin film 13 has a refractive index higher than that of the first dielectric thin film 12, the second dielectric thin film 13 can suppress the light from spreading excessively in the horizontal direction of the ABX₃ type ferroelectric thin film 11. Therefore, the optical waveguide of the optical waveguiding medium 1 can be fabricated without processing the ABX₃ type ferroelectric thin film 11.

The substrate 10 is not particularly limited as long as it has a refractive index lower than that of the ABX₃ type ferroelectric thin film 11, but any substrate is preferable if the ABX₃ type ferroelectric thin film 11 can be formed thereon as an epitaxial film with excellent crystallinity. In this sense, the substrate may preferably be a sapphire single crystal substrate or a silicon single crystal substrate. The crystal orientation of the substrate 10 is not particularly limited.

The lithium niobate films, and the lithium tantalate films have the property of being easily formed as c-axis oriented epitaxial films on single crystal substrates of various crystal orientations. Since the crystals constituting the c-axis oriented lithium niobate film or lithium tantalate film have three-fold symmetry, it is desirable that the underlying substrate 10 also has the same symmetry. In the case of a sapphire single crystal substrate, the c-plane is preferable, and in the case of a silicon single crystal substrate, the (111) plane is preferable.

Here, an epitaxial film is a film that is aligned with respect to the crystal orientation of the underlying substrate or underlying film, and when the film plane is the X-Y plane and the film thickness direction is the Z axis, the crystals are aligned in the X-axis, Y-axis, and Z-axis directions. For example, an epitaxial film can be proven by first confirming the peak intensity at the orientation position by 2θ-θ X-ray diffraction and secondly confirming the pole.

Specifically, when the measurement is first performed by 2θ-θ X-ray diffraction, all peak intensities other than the target plane must be 10% or less, preferably 5% or less, of the maximum peak intensity of the target plane. For example, in a c-axis oriented epitaxial film of lithium niobate, the peak intensity of planes other than the (00L) plane is 10% or less, preferably 5% or less, of the maximum peak intensity of the (00L) plane. (00L) is a general designation for equivalent planes such as (001) and (002).

Secondly, it is necessary that the poles are visible in the pole measurement. The above-mentioned first condition for confirming the peak intensity at the orientation position only indicates the orientation in one direction, and even if the above-mentioned first condition is obtained, if the crystal orientation is not aligned within the plane, the intensity of the X-rays will not increase at a specific angle position and the poles will not be seen. Since LiNbO₃ has a trigonal crystal structure, there are three poles of LiNbO₃ (014) in a single crystal.

In the case of lithium niobate films, it is known that epitaxial growth occurs in a so-called twin crystal state, in which crystals rotated 180° around the c-axis are symmetrically bonded. In this case, three poles are symmetrically bonded to two, resulting in six poles. In addition, when a lithium niobate film is formed on a silicon single crystal substrate with a (100) surface, the substrate is four-fold symmetric, so 4×3=12 poles are observed. In this invention, lithium niobate films epitaxially grown in a twin crystal state are also included in the epitaxial film.

The composition of the lithium niobate film is LiₓNbA_{y}O_{z}. A represents an element other than Li, Nb, and O. x is 0.5 [symbol] 1.2, preferably 0.9 [symbol] 1.05. y is 0 [symbol] 0.5. z is 1.5 [symbol] 4, preferably 2.5 [symbol] 3.5. The elements A include K, Na, Rb, Cs, Be, Mg, Ca, Sr, Ba, Ti, Zr, Hf, V, Cr, Mo, W, Fe, Co, Ni, Zn, Sc, Ce, etc., and may be a combination of two or more elements.

The thickness of the ABX₃ type ferroelectric thin film 11 is preferably 2 μm or less. This is because if the thickness is greater than 2 μm, it becomes difficult to form a high-quality film. On the other hand, if the thickness of the ABX₃ type ferroelectric thin film 11 is excessively thin, the light confinement in the ABX₃ type ferroelectric thin film 11 becomes weak, and light leaks into the substrate 10 or cladding layer 16. In addition, when an electric field is applied to the ABX₃ type ferroelectric thin film 11, the change in the effective refractive index of the optical waveguide may possibly become small. For this reason, the thickness of the ABX₃ type ferroelectric thin film 11 is preferably about 1/10 or more of the wavelength of the light used.

The ABX₃ type ferroelectric thin film 11 is preferably formed by a film formation method such as a sputtering method, a CVD (Chemical Vapor Deposition) method, or a sol-gel method. The c-axis of the ABX₃ type ferroelectric thin film 11 is oriented perpendicular to the main surface of the substrate 10, and the optical refractive index changes in proportion to the electric field when an electric field is applied parallel to the c-axis.

When a sapphire single crystal substrate is used as the substrate 10, the ABX₃ type ferroelectric thin film 11 can be epitaxially grown directly on the sapphire single crystal substrate. When a silicon single crystal substrate is used as the substrate 10, the ABX₃ type ferroelectric thin film 11 is formed by epitaxial growth through a cladding layer (not shown). The cladding layer (not shown) that has a refractive index lower than that of the ABX₃ type ferroelectric thin film 11 and is suitable for epitaxial growth can be used. For example, if Y₂O₃ is used as the cladding layer (not shown), a high-quality ABX₃-type ferroelectric thin film 11 can be formed.

In addition, a method of thinly polishing or slicing a ferroelectric ABX₃ crystal substrate is also known as a method of forming the ABX₃-type ferroelectric thin film 11. This method has the advantage of obtaining the same characteristics as a single crystal, and can be applied to the present invention.

The optical waveguide medium 1 can be produced at a high level of mass productivity and low cost by stacking the ABX₃-type ferroelectric thin film 11, the first dielectric thin film 12, the second dielectric thin film 13, the third dielectric thin film 14, and the electrode layer 15 on the substrate 10 in this order, without using a bonding technique. The hybrid-type optical waveguide medium 1 produced in this way has a low-defect film structure with precisely controlled film thickness, and can realize a low-loss optical waveguide.

### Second Embodiment

Next, an optical modulation element according to a second embodiment of the present invention will be described hereinafter with reference to the drawings. The same components as those in the first embodiment are denoted by the same reference numerals and will not be described hereinafter. The same operations as those in the first embodiment will not be described hereinafter.

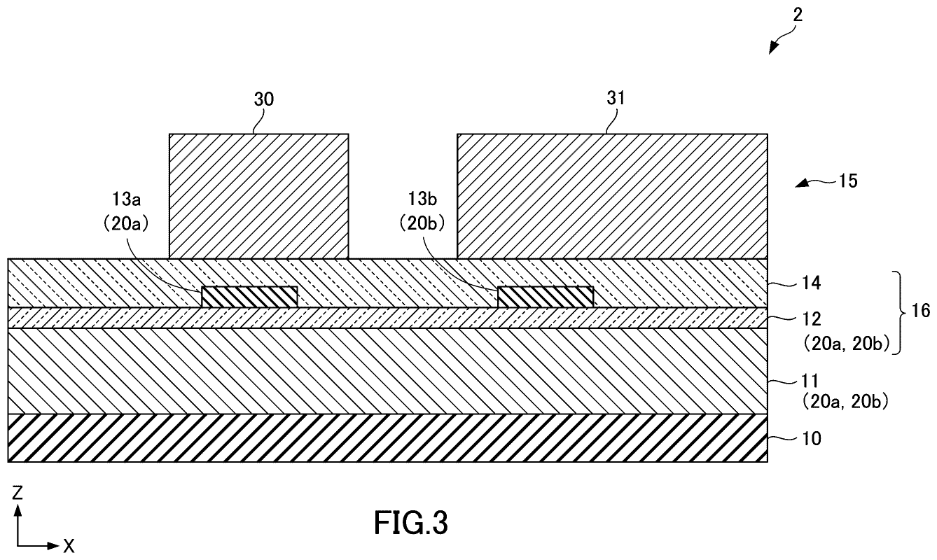

FIG. 2 is a plan view showing the configuration of an optical modulation element 2 according to a second embodiment of the present invention, illustrating the entire optical modulation element including the traveling wave electrode. FIG. 3 is a cross-sectional view of the optical modulation element 2 taken along line A-A in FIG. 2.

As shown in FIG. 2, the optical modulation element 2 includes a Mach-Zehnder optical waveguide 20 formed above the substrate 10 and having first and second optical waveguides 20a and 20b arranged parallel to each other, a signal electrode 30 arranged along the first optical waveguide 20a, and a ground electrode 31 arranged along the second optical waveguide 20b.

The Mach-Zehnder optical waveguide 20 is an optical waveguide having a Mach-Zehnder interferometer structure, and has first and second optical waveguides 20a and 20b branched from a single input optical waveguide 20i by a splitter portion 20c, and the first and second optical waveguides 20a and 20b are combined into a single output optical waveguide 20o through a combiner portion 20d. The input light to the input optical waveguide 20i is split by the splitter portion 20c and travels through the first and second optical waveguides 20a and 20b, respectively, before being combined by the combiner portion 20d and output from the output optical waveguide 20o as modulated light.

One end 30i of the signal electrode 30 is a signal input end to which an electrical signal (modulation signal) is input. The other end 30o of the signal electrode 30 is connected to the ground electrode 31 through a termination resistor not shown. As a result, the signal electrode 30 and the ground electrode 31 function as traveling wave electrodes.

As shown in FIG. 3, the optical modulation element 2 has a multi-layer structure in which an ABX₃ type ferroelectric thin film 11, a first dielectric thin film 12, a second dielectric thin film 13 (13a, 13b), a third dielectric thin film 14, and an electrode layer 15 are stacked in this order on a substrate 10. The first dielectric thin film 12, the second dielectric thin films 13a, 13b, and the third dielectric thin film 14 embed the second dielectric thin films 13a, 13b with the first dielectric thin film 12 and the third dielectric thin film 14, thereby forming first and second buried optical waveguide structures adjacent to each other.

In other words, the optical modulation element 2 of this embodiment is configured by adding, to the structure of the optical waveguiding medium 1 of the first embodiment, two first and second optical waveguides 20a, 20b each composed of a second dielectric thin film 13a, 13b, a first dielectric thin film 12, and an ABX₃ type ferroelectric thin film 11, and by providing an electrode layer 15 on the upper surface of the third dielectric thin film 14. The electrode layer 15 includes a traveling wave electrode composed of a signal electrode 30 and a ground electrode 31 for applying an electric field to the ABX₃ type ferroelectric thin film 11.

The first and second optical waveguides 20a, 20b are configured by optical coupling between the second dielectric thin films 13a, 13b and the Z-cut (c-axis oriented) ABX₃ type ferroelectric thin film 11 having an electro-optic effect. Therefore, the refractive indexes of the first and second optical waveguides 20a, 20b change to +Δn and −Δn, respectively, due to the electric field applied to the ABX₃ type ferroelectric thin film 11 from the signal electrode 30 and the ground electrode 31, and the phase difference between the pair of optical waveguides changes. Signal light modulated by this change in phase difference is output from the output optical waveguide 20o.

The signal electrode 30 is provided overlapping the second dielectric thin film 13a constituting the first optical waveguide 20a to modulate the light traveling in the first optical waveguide 20a. The ground electrode 31 is provided overlapping the second dielectric thin film 13b constituting the second optical waveguide 20b to modulate the light traveling in the second optical waveguide 20b.

The signal electrode 30 and the ground electrode 31 may be made of any material having high electrical conductivity, but to reduce the signal propagation loss at high frequencies, it is preferable to use a metal material having high electrical conductivity, such as Au, Cu, Ag, or Pt.

The cladding layer 16 also functions as a buffer layer that prevents the light propagating through the first and second optical waveguides 20a and 20b from being absorbed by the signal electrode 30 and the ground electrode 31.

The thicker the cladding layer 16, the better to reduce the light absorption of the signal electrode 30 and the ground electrode 31 (hereinafter, collectively simply referred to as “electrodes”), and the thinner the cladding layer 16, the better to apply a high electric field to the first and second optical waveguides 20a and 20b. In other words, there is a trade-off relationship between the light absorption of the electrodes and the voltage applied to the electrodes, so that it is necessary to set an appropriate film thickness depending on the purpose. A higher dielectric constant of the cladding layer 16 is preferable because VπL (an index representing electric field efficiency) can be reduced, and a lower refractive index of the cladding layer 16 is preferable because the cladding layer 16 can be made thinner.

Here, Vπ is the half-wave voltage, which is defined as the difference between the voltage V1 at which the optical output of the optical modulation element is at its maximum and the voltage V2 at which it is at its minimum, and means the drive voltage. The electric field efficiency VπL is the product of the drive voltage, which is the voltage applied to the signal electrode 30, and the electrode length L of the signal electrode 30, and is an index representing the performance of the optical modulator. This indicates that the smaller the electric field efficiency VπL is, the smaller the size and the lower the drive voltage.

Normally, a material with a high dielectric constant also has a high refractive index, so that it is important to select a material with a high dielectric constant and a relatively low refractive index, considering the balance between the two. As an example, Al₂O₃ has a relative dielectric constant of about 9 and a refractive index of about 1.6, and thus is a preferable material for the cladding layer 16.

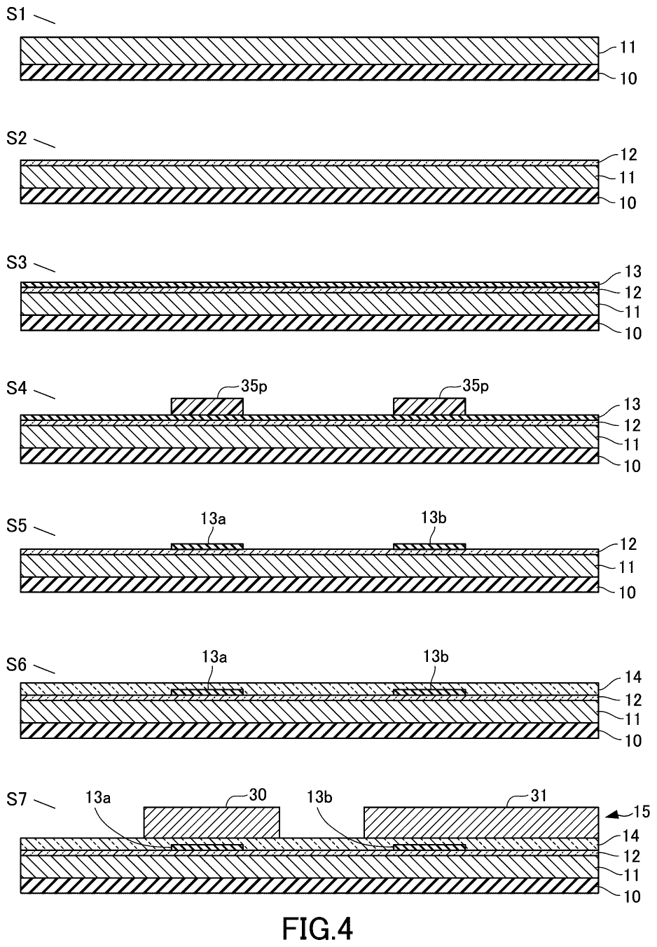

FIG. 4 is a diagram for explaining the manufacturing process of the optical modulation element 2 according to this embodiment.

As shown in FIG. 4, in manufacturing the optical modulation element 2, a sapphire single crystal substrate is prepared as the substrate 10, and an ABX₃ type ferroelectric thin film 11 such as a lithium niobate film is formed by sputtering over the entire main surface of the substrate 10. Furthermore, the upper surface of the ABX₃ type ferroelectric thin film 11 is planarized by chemical mechanical polishing (CMP) (step S1).

Next, a first dielectric thin film 12 made of SiO₂, Al₂O₃, or the like, having a thickness of 100 to 600 nm is formed by CVD on the upper surface of the ABX₃ type ferroelectric thin film 11 (step S2).

Next, a second dielectric thin film 13 made of Si₃N₄ and having a thickness of 100 [symbol] 100 nm is formed on the upper surface of the first dielectric thin film 12 by the CVD method (step S3).

Next, a photoresist is spin-coated on the upper surface of the second dielectric thin film 13 and cured. Furthermore, the photoresist is exposed and developed using a photomask, thereby forming a resist pattern 35p corresponding to the second dielectric thin films 13a and 13b (step S4).

Next, the second dielectric thin film 13 is etched using the resist pattern 35p as a mask, thereby forming the second dielectric thin films 13a and 13b. As an etching method, RIE (Reactive Ion Etching) or ion milling can be used. Then, the resist pattern 35p is peeled off (step S5).

Next, a third dielectric thin film 14 made of SiO₂ or Al₂O₃ or the like is formed on the first dielectric thin film 12 and the second dielectric thin films 13a and 13b by the CVD method. Furthermore, the upper surface of the third dielectric thin film 14 is planarized by CMP (step S6). In this way, the second dielectric thin films 13a and 13b are buried with the first dielectric thin film 12 and the third dielectric thin film 14, and the first and second buried optical waveguide structures adjacent to each other are formed.

Then, an electrode layer 15 including a signal electrode 30 and a ground electrode 31 that respectively cover the upper surfaces of the second dielectric thin films 13a and 13b is formed in order on the upper surface of the third dielectric thin film 14 (step S7). With the above process, the optical modulation element 2 is completed.

### Third Embodiment

Next, an optical modulation element according to a third embodiment of the present invention will be described hereinafter with reference to the drawings. It should be noted that the same components as those in the first or second embodiment are given the same reference numerals, and their explanations are omitted appropriately. Also, explanations of the same operations as those in the first or second embodiment are omitted appropriately.

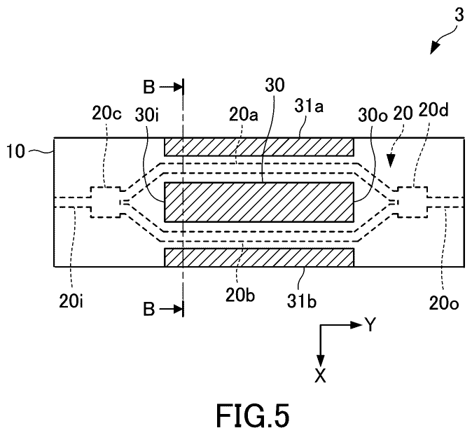

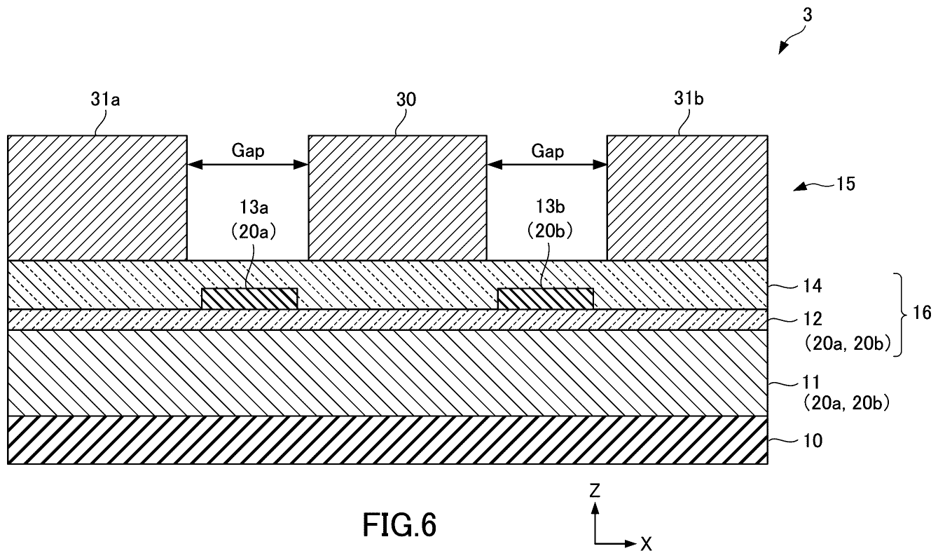

FIG. 5 is a plan view showing the configuration of the light modulation element 3 according to the third embodiment of the present invention, illustrating the entire light modulation element 3 including the traveling wave electrodes. FIG. 6 is a cross-sectional view of the light modulation element 3, taken along line B-B in FIG. 5.

As shown in FIG. 5, the optical modulation element 3 is formed above the substrate 10 and includes a Mach-Zehnder optical waveguide 20 having first and second optical waveguides 20a, 20b arranged parallel to each other, a signal electrode 30 arranged between the first and second optical waveguides 20a, 20b as seen in a plan view, a ground electrode 31a arranged at a position facing the signal electrode 30 across the first optical waveguide 20a as seen in a plan view, and a ground electrode 31b arranged at a position facing the signal electrode 30 across the second optical waveguide 20b as seen in a plan view.

The first and second optical waveguides 20a, 20b are composed of second dielectric thin films 13a, 13b and an X-cut (a-axis oriented) ABX₃ type ferroelectric thin film 11 having an electro-optic effect. Therefore, the refractive indexes of the first and second optical waveguides 20a and 20b change to +Δn and −Δn, respectively, due to the electric field applied to the ABX₃ type ferroelectric thin film 11 from the signal electrode 30 and the ground electrodes 31a and 31b, and the phase difference between the pair of optical waveguides changes. Signal light modulated by this change in phase difference is output from the output optical waveguide 20o.

As shown in FIG. 6, the optical modulation element 3 has a multi-layer structure in which an ABX₃ type ferroelectric thin film 11, a first dielectric thin film 12, a second dielectric thin film 13a, 13b, a third dielectric thin film 14, and an electrode layer 15 are stacked in this order on a substrate 10. The electrode layer 15 includes a signal electrode 30 and ground electrodes 31a, 31b for applying an electric field to the ABX₃ type ferroelectric thin film 11.

The signal electrode 30 is provided between the second dielectric thin films 13a, 13b constituting the first and second optical waveguides 20a, 20b as seen in a plan view to modulate the light traveling in the first and second optical waveguides 20a, 20b. The ground electrodes 31a, 31b are arranged to sandwich the signal electrode 30 to modulate the light traveling in the first and second optical waveguides 20a, 20b.

In other words, the light modulation element 3 of this embodiment differs from the light modulation element 2 of the second embodiment in the arrangement of the signal electrode 30 and the ground electrodes 31a, 31b because the ABX₃ type ferroelectric thin film 11 is X-cut (a-axis oriented). The other configurations and operations of the light modulation element 3 of this embodiment are the same as those of the light modulation element 2 of the second embodiment.

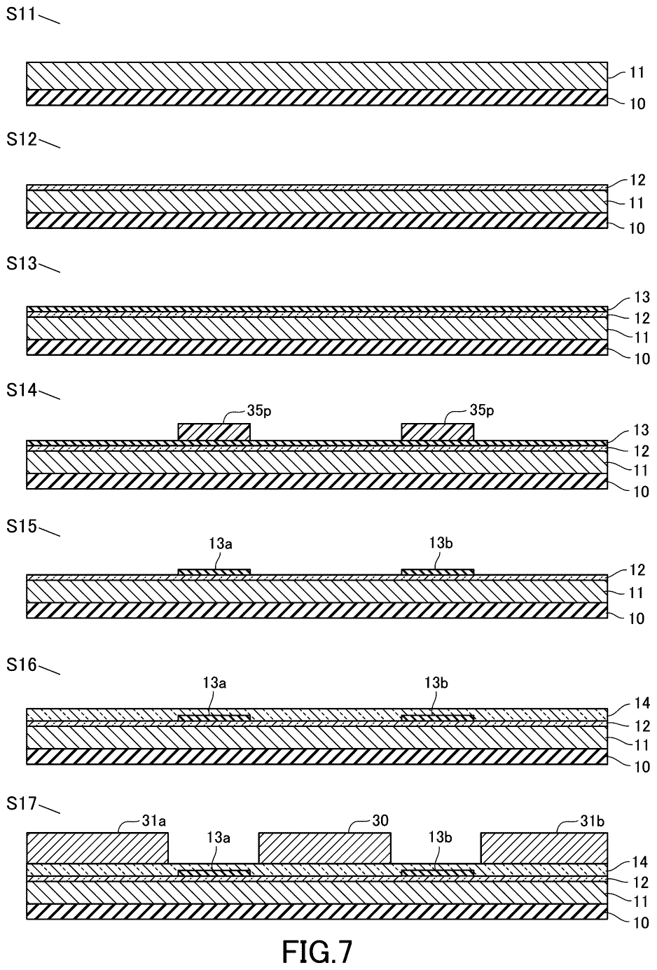

FIG. 7 is a diagram that outlines the manufacturing process of the light modulation element 3 of this embodiment.

Steps S11 [symbol] S16 are the same as steps S1 [symbol] S6 in the manufacturing process of the light modulation element 2 of the second embodiment.

After step S16, an electrode layer 15 including a signal electrode 30 provided between the second dielectric thin films 13a and 13b as seen in a plan view, a ground electrode 31a provided at a position facing the signal electrode 30 across the second dielectric thin film 13a as seen in a plan view, and a ground electrode 31b provided at a position facing the signal electrode 30 across the second dielectric thin film 13b as seen in a plan view is formed in this order on the upper surface of the third dielectric thin film 14 (step S17). The optical modulation element 3 is thus completed.

### EXAMPLES

### Example 1

The electric field distribution (light intensity distribution) of light propagating through the optical waveguide formed by the second dielectric thin film 13 and the ABX₃ type ferroelectric thin film 11 of the optical waveguide medium 1 of the first embodiment was obtained by simulation.

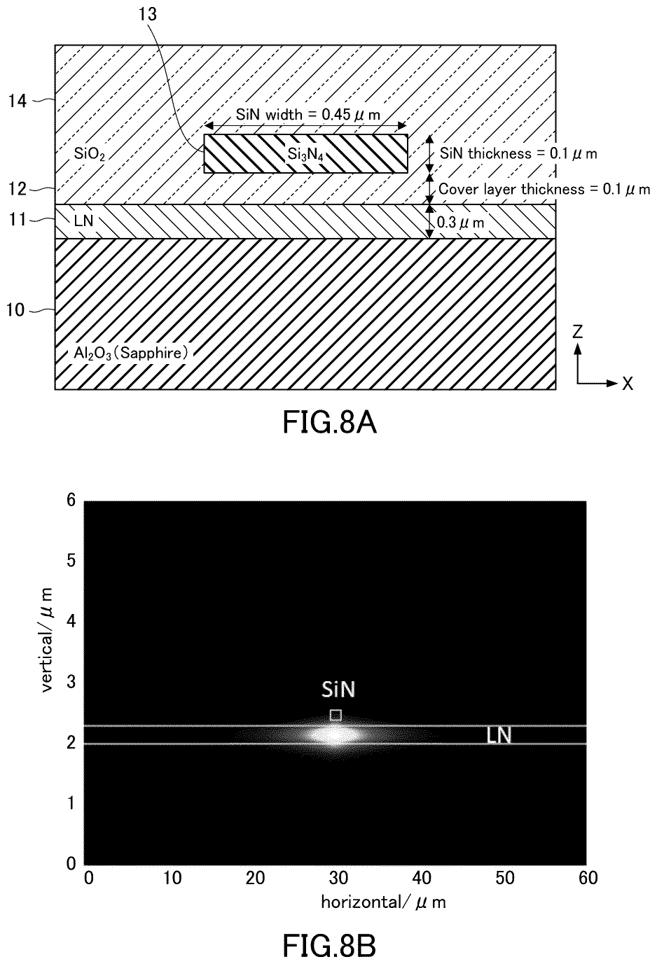

FIG. 8A shows a simulation model of the optical waveguide medium 1 used in this simulation. The information of each layer constituting this simulation model is as follows:

The substrate 10 is a sapphire single crystal (Al₂O₃) substrate. The ABX₃ type ferroelectric thin film 11 is a lithium niobate (LN) film with a thickness of 0.3 μm. The first dielectric thin film 12 is SiO₂ with a thickness of 0.1 μm. The second dielectric thin film 13 is Si₃N₄ with a rectangular parallelepiped shape with a thickness of 0.1 μm and a width of 0.45 μm. The third dielectric thin film 14 is SiO₂ with a thickness of 0.6 μm (here, the thickness of the part where the second dielectric thin film 13 is formed is 0.5 μm).

FIG. 8B shows the simulation results. In FIG. 8B, the parts with a strong electric field are displayed in white, and the parts with a weak electric field are displayed in black. The two white horizontal lines respectively indicate the positions of the ABX₃ type ferroelectric thin film 11. The white rectangle indicates the position of the second dielectric thin film 13.

The simulation results shown in FIG. 8B show that the second dielectric thin film 13 and the ABX₃ type ferroelectric thin film 11 are optically coupled, and the position where the light intensity is maximum is contained within the ABX₃ type ferroelectric thin film 11.

### Example 2

The electric field efficiency VπL when light with a wavelength of 637 nm is propagated through the first and second optical waveguides 20a and 20b of the optical modulation element 2 of the second embodiment was obtained by simulation.

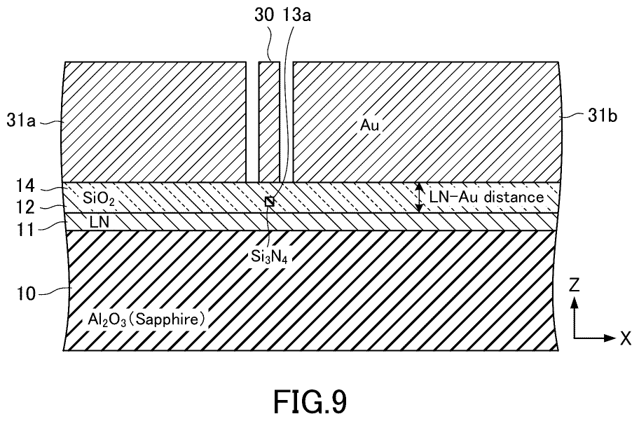

FIG. 9 shows a simulation model of the optical modulation element 2 used in this simulation. FIG. 9 is an enlarged view of the vicinity of the first optical waveguide 20a, and the second optical waveguide 20b is not shown.

In the simulation model of this example, the ground electrode 31 is composed of a pair of electrodes 31a and 31b that sandwich the signal electrode 30 from both sides. The information of each layer that constitutes this simulation model is as follows.

The substrate 10 is a sapphire single crystal (Al₂O₃) substrate. The ABX₃ type ferroelectric thin film 11 is a lithium niobate (LN) film with a thickness of 0.3 μm. The first dielectric thin film 12 is SiO₂ with a thickness of 0.1 μm. The second dielectric thin films 13a and 13b are rectangular parallelepiped Si₃N₄ with a thickness of 0.1 μm and a width of 0.45 μm. The third dielectric thin film 14 is SiO₂ with a thickness of 0.6 μm (here, the thickness of the part where the second dielectric thin film 13 is formed is 0.5 μm).

The distance between the second dielectric thin films 13a and 13b that respectively constitute the first and second optical waveguides 20a and 20b is 60 μm. The signal electrode 30 and the ground electrodes 31a and 31b are Au with a thickness of 2 μm. The width of the signal electrode 30 is 3 μm. The distance between the signal electrode 30 and the ground electrodes 31a, 31b is 2 μm.

The above simulation revealed that the electric field efficiency VπL of the simulation model of this embodiment is 9.9 Vcm for light with a wavelength of 637 nm.

### Example 3

The appropriate width and thickness of the second dielectric thin film 13 when light with a wavelength of 637 nm is propagated through the first and second optical waveguides 20a, 20b of the optical modulation element 2 of the second embodiment were determined by simulation. The information of each layer constituting the simulation model of the optical modulation element 2 used in this simulation is the same as that of the simulation model of Example 2, except for the width and thickness of the second dielectric thin film 13.

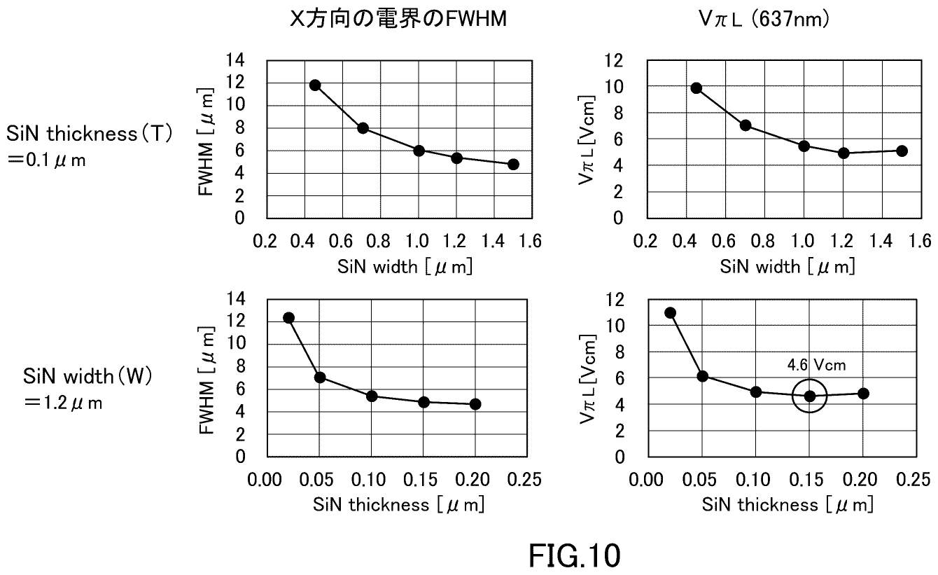

The graph in the upper left of FIG. 10 shows the simulation results of the full width at half maximum (FWHM) of the light intensity in the X direction (horizontal direction) when the width W (SiN width) of the second dielectric thin film 13 made of Si₃N₄ is changed while the thickness T (SiN thickness) of the second dielectric thin film 13 made of Si₃N₄ is fixed at 0.1 μm. Here, the FWHM of the light intensity in the X direction is the distance between two positions in the X direction where the electric field intensity drops by 3 dB from the maximum value in the electric field distribution when light with a wavelength of 637 nm is propagated through the first and second optical waveguides 20a and 20b.

From these simulation results, it was found that the wider the width W of the second dielectric thin film 13, the smaller the FWHM becomes, and the stronger the light confinement in the X direction in the ABX₃ type ferroelectric thin film 11 becomes.

The graph in the upper right of FIG. 10 shows the simulation results of the electric field efficiency VπL when the width W of the second dielectric thin film 13 is changed while the thickness T of the second dielectric thin film 13 is fixed at 0.1 μm. From these simulation results, it was found that the electric field efficiency VπL is substantially minimum when the width W of the second dielectric thin film 13 is 1.2 μm.

The graph in the lower left of FIG. 10 shows the simulation results of the FWHM of the light intensity in the X direction when the thickness T of the second dielectric thin film 13 is changed while the width W of the second dielectric thin film 13 is fixed at 1.2 μm. From these simulation results, it was found that the wider the width W of the second dielectric thin film 13 is, the smaller the FWHM becomes, and the stronger the light confinement in the X direction in the ABX₃ type ferroelectric thin film 11 becomes.

The graph at the bottom right of FIG. 10 shows the simulation results of the electric field efficiency VπL when the thickness T of the second dielectric thin film 13 is changed while the width W of the second dielectric thin film 13 is fixed at 1.2 μm. From these simulation results, it was found that when the thickness T of the second dielectric thin film 13 is 0.15 μm, the electric field efficiency VπL is 4.6 Vcm, and the electric field efficiency VπL is substantially minimum. In other words, it was found that the preferred size of the second dielectric thin film 13 at which the electric field efficiency VπL is substantially minimum for light with a wavelength of 637 nm is a thickness T of 0.15 μm and a width W of 1.2 μm.

### Example 4

The appropriate distance between the lower surface of the signal electrode 30 and the ground electrodes 31a, 31b (hereinafter, collectively simply referred to as “electrodes”) and the upper surface of the ABX₃ type ferroelectric thin film 11 when light with a wavelength of 637 nm is propagated through the first and second optical waveguides 20a, 20b of the optical modulation element 2 of the second embodiment was obtained by simulation. The information of each layer constituting the simulation model of the optical modulation element 2 used in this simulation is the same as that of the simulation model of Example 2, except for the distance D between the lower surface of the electrode and the upper surface of the ABX₃ type ferroelectric thin film 11, i.e., the thickness of the cladding layer 16.

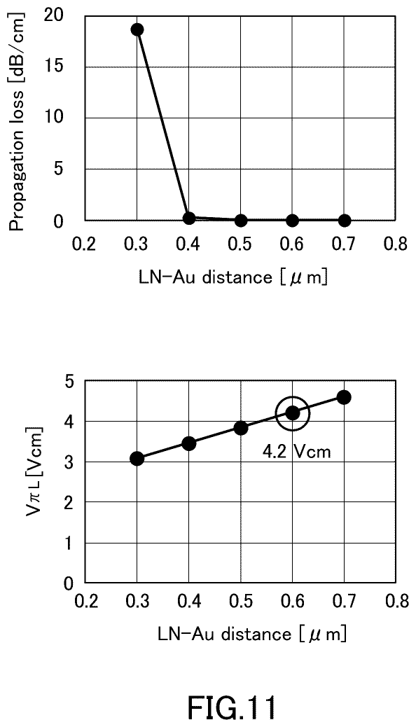

The upper graph of FIG. 11 shows the simulation results of the propagation loss (PL) due to light absorption at the electrodes when the distance D (LN-Au distance) between the lower surface of the electrode and the upper surface of the ABX₃ type ferroelectric thin film 11 is changed. From the simulation results, it was found that when the distance D is 0.6 μm or more, the propagation loss PL becomes 0 dB/cm.

The lower graph of FIG. 11 shows the simulation results of the electric field efficiency VπL when the distance D between the lower surface of the electrode and the upper surface of the ABX₃ type ferroelectric thin film 11 is changed. From the simulation results, it was found that the smaller the distance D, the smaller the electric field efficiency VπL becomes.

In other words, it was found that for light with a wavelength of 637 nm, the preferable distance D, at which the propagation loss PL becomes 0 dB/cm and the electric field efficiency VπL becomes substantially minimum, is 0.6 μm, and the electric field efficiency VπL at this time is 4.2 Vcm.

### Example 5

When the material of the cladding layer 16 of the optical modulation element 2 of the second embodiment is aluminum oxide (Al₂O₃), the appropriate width of the second dielectric thin film 13 for light with a wavelength of 637 nm was obtained by simulation. Here, the thickness T of the second dielectric thin film 13 is 0.15 μm.

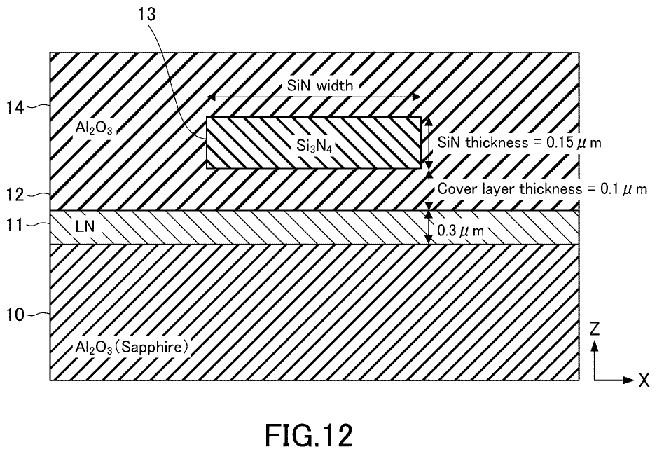

FIG. 12 shows a simulation model of the optical modulation element 2 used in this simulation. The simulation model of this embodiment is the same as the simulation model of Example 2 except for the material of the cladding layer 16 and the thickness T and width W of the second dielectric thin film 13.

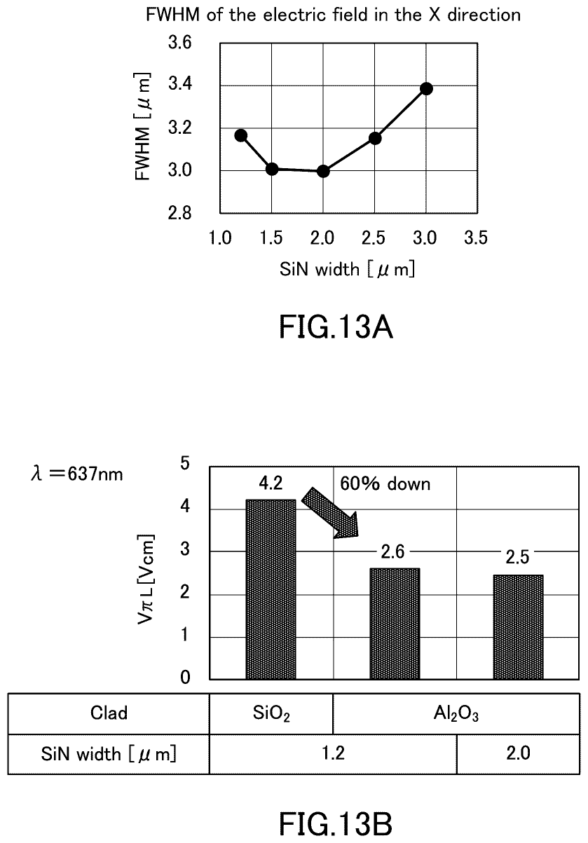

FIG. 13A shows the simulation results of the FWHM of the light intensity in the X direction when the width W of the second dielectric thin film 13 is changed. From these simulation results, it was found that the FWHM is substantially minimum when the width W of the second dielectric thin film 13 is 2.0 μm.

FIG. 13B shows the simulation results of the electric field efficiency VπL when the material of the cladding layer 16 and the width W of the second dielectric thin film 13 are changed.

When the material of the cladding layer 16 was SiO₂ and the width W of the second dielectric thin film 13 was 1.2 μm, the electric field efficiency VπL was 4.2 Vcm. When the material of the cladding layer 16 was Al₂O₃ and the width W of the second dielectric thin film 13 was 1.2 μm, the electric field efficiency VπL was 2.6 Vcm. When the material of the cladding layer 16 was Al₂O₃ and the width W of the second dielectric thin film 13 was 2.0 μm, the electric field efficiency VπL was 2.5 Vcm.

In other words, when the width W of the second dielectric thin film 13 was 1.2 μm, it was found that by changing the material of the cladding layer 16 from SiO₂ to Al₂O₃, the electric field efficiency VπL could be reduced to about 60% before the change. From the fact that the dielectric constant of Al₂O₃ is 9 and the dielectric constant of SiO₂ is 4, it is considered because the dielectric constant of the cladding layer 16 became larger.

### Example 6

The appropriate thickness of the first dielectric thin film 12 when light with a wavelength of 637 nm is propagated through the first and second optical waveguides 20a and 20b of the optical modulation element 2 of the second embodiment was determined by simulation. Here, the second dielectric thin film 13 has a thickness T of 0.15 μm and a width W of 2.0 μm.

The information of each layer constituting the simulation model of the optical modulation element 2 used in this simulation is the same as that of the simulation model of Example 5 except for the thickness of the first dielectric thin film 12 and the width W of the second dielectric thin film 13.

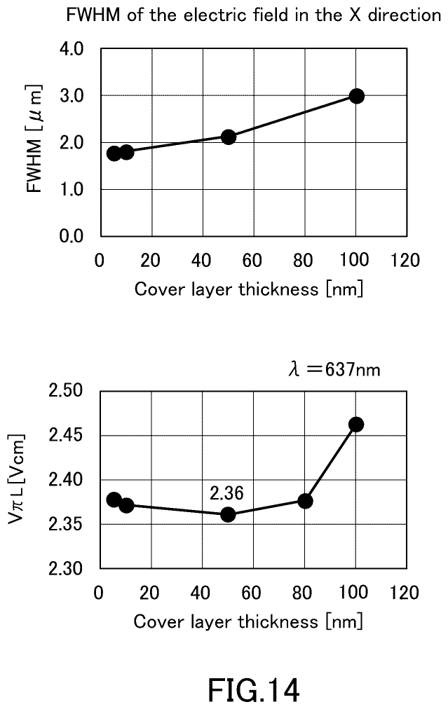

The upper graph in FIG. 14 shows the simulation results of the FWHM of the light intensity in the X direction when the thickness (cover layer thickness) of the first dielectric thin film 12 is changed. From the simulation results, it was found that the thinner the thickness of the first dielectric thin film 12, the smaller the FWHM becomes, and the stronger the light confinement in the X direction in the ABX₃ type ferroelectric thin film 11 becomes.

The lower graph of FIG. 14 shows the simulation results of the electric field efficiency VπL when the thickness (cover layer thickness) of the first dielectric thin film 12 is changed. From the simulation results, it was found that when the thickness of the first dielectric thin film 12 is 50 nm, the electric field efficiency VπL is substantially minimized, and its value is 2.36 Vcm.

From these simulation results, it was found that if the thickness of the first dielectric thin film 12 is 80 nm or less, the electric field efficiency VπL becomes 2.4 Vcm or less for light with a wavelength of 637 nm. In other words, a preferable VπL was obtained even if the thickness of the first dielectric thin film 12 is 0.

### Example 7

When the material of the first dielectric thin film 12 of the optical modulation element 2 of the second embodiment is SiO₂, the electric field efficiency VπL for light with a wavelength of 637 nm was obtained by simulation.

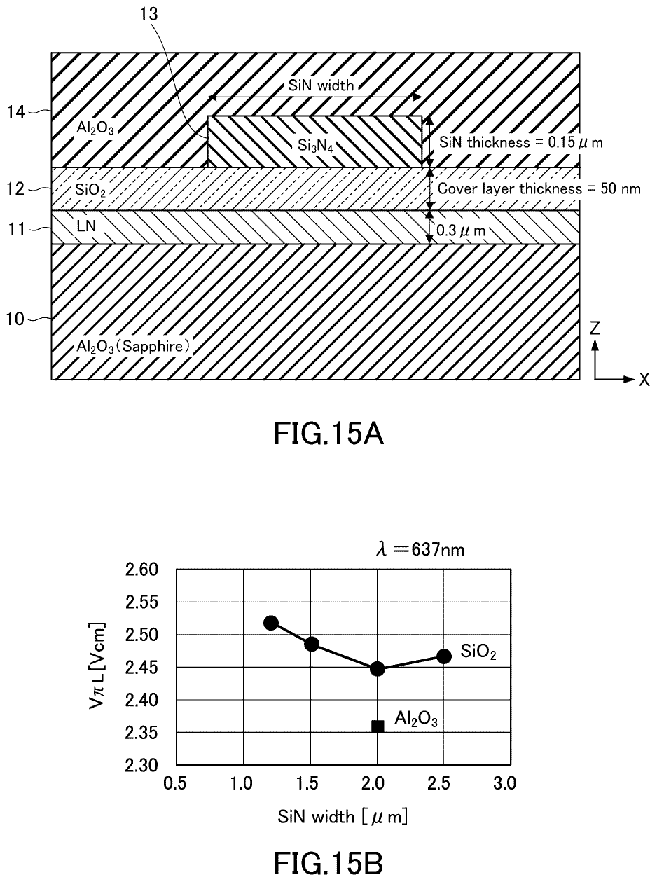

FIG. 15A is a diagram showing a simulation model of the optical modulation element 2 used in this simulation. The simulation model of this example is the same as the simulation model of Example 6 except for the material and thickness of the first dielectric thin film 12 and the width W of the second dielectric thin film 13.

FIG. 15B shows the simulation results of the electric field efficiency VπL (circle marks) when the width W of the second dielectric thin film 13 is changed. The graph in FIG. 15B also shows VπL (square marks) when the first dielectric thin film 12 is Al₂O₃ and the width W of the second dielectric thin film 13 is 2.0 μm, as a comparative example.

From the simulation results, when the thickness of the first dielectric thin film 12 made of SiO₂ is 2.0 μm, the electric field efficiency VπL is substantially minimum, and the value is 2.45 Vcm. In other words, the electric field efficiency VπL when the first dielectric thin film 12 is made of SiO₂ is increased by about 0.1 Vcm compared to when the first dielectric thin film 12 is made of Al₂O₃. This is considered to be because the dielectric constant of SiO₂ is smaller than that of Al₂O₃.

### Example 8

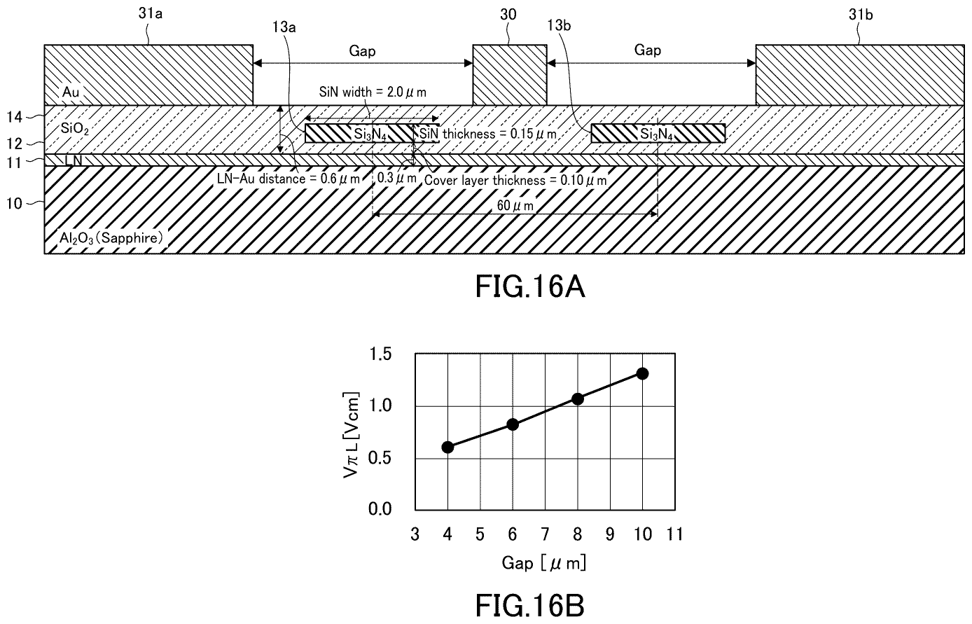

The electric field efficiency VπL when light with a wavelength of 637 nm is propagated through the first and second optical waveguides 20a and 20b of the optical modulation element 3 of the third embodiment was obtained by simulation. FIG. 16A is a diagram showing a simulation model of the optical modulation element 3 used in this simulation. The information of each layer constituting the simulation model of this example is as follows.

The substrate 10 is a sapphire single crystal (Al₂O₃) substrate. The ABX₃ type ferroelectric thin film 11 is an X-cut (a-axis oriented) lithium niobate (LN) film with a thickness of 0.3 μm. The first dielectric thin film 12 is SiO₂ with a thickness of 100 nm. The second dielectric thin films 13a and 13b are rectangular parallelepiped Si₃N₄ with a thickness of 0.15 μm and a width of 2.0 μm. The third dielectric thin film 14 is SiO₂ with a thickness of 0.5 μm (here, the thickness at the location where the second dielectric thin film 13 is formed is 0.35 μm).

The distance between the second dielectric thin films 13a and 13b that respectively constitute the first and second optical waveguides 20a and 20b is 60 μm. The signal electrode 30 and the ground electrodes 31a and 31b are Au with a thickness of 2 μm. The width of the signal electrode 30 varies depending on the electrode spacing and is 50 to 56 μm. The distance D between the lower surface of the electrode and the upper surface of the ABX₃ type ferroelectric thin film 11 is 0.6 μm.

FIG. 16B shows the simulation results of the electric field efficiency VπL when the gap G between the signal electrode 30 and the ground electrodes 31a, 31b is changed. From these simulation results, it was found that the smaller the gap G, the smaller the electric field efficiency VπL becomes, and when the gap G is 4 μm, the electric field efficiency VπL is 0.61 Vcm.

### Example 9

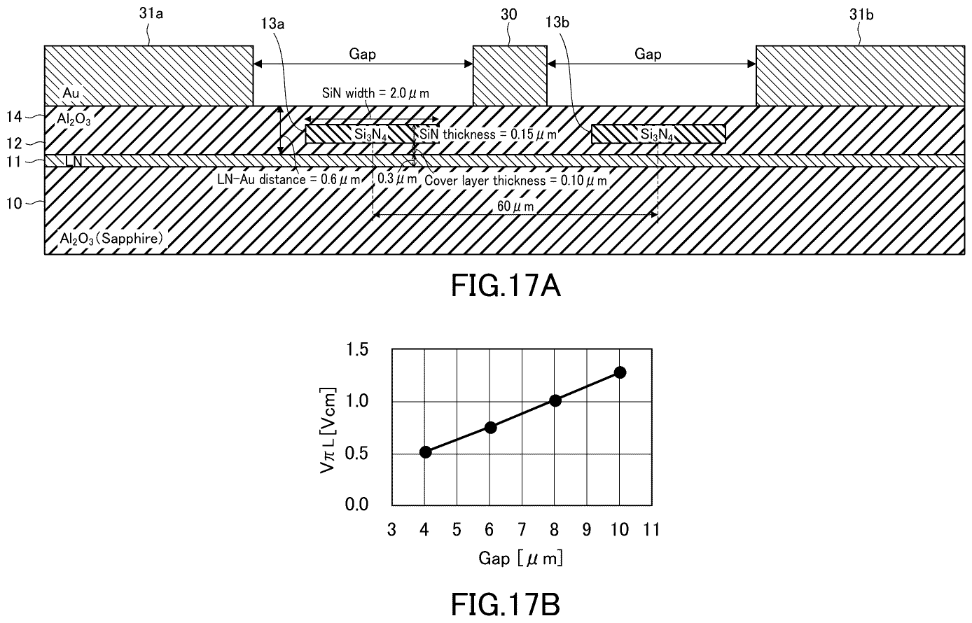

The electric field efficiency VπL when light with a wavelength of 637 nm is propagated through the first and second optical waveguides 20a and 20b of the optical modulation element 3 of the third embodiment was obtained by simulation. FIG. 17A is a diagram showing a simulation model of the optical modulation element 3 used in this simulation. The information of each layer constituting the simulation model of this example is as follows.

The substrate 10 is a sapphire single crystal (Al₂O₃) substrate. The ABX₃ type ferroelectric thin film 11 is an X-cut (a-axis oriented) lithium niobate (LN) film with a thickness of 0.3 μm. The first dielectric thin film 12 is aluminum oxide (Al₂O₃) with a thickness of 100 nm. The second dielectric thin films 13a and 13b are rectangular parallelepiped Si₃N₄ with a thickness of 0.15 μm and a width of 2.0 μm. The third dielectric thin film 14 is made of Al₂O₃ and has a thickness of 0.5 μm (here, the thickness where the second dielectric thin film 13 is formed is 0.35 μm).

The distance between the second dielectric thin films 13a and 13b respectively constituting the first and second optical waveguides 20a and 20b is 60 μm. The signal electrode 30 and the ground electrodes 31a and 31b are made of Au and have a thickness of 2 μm. The width of the signal electrode 30 varies depending on the electrode spacing and is 50 [symbol] 56 μm. The distance D between the lower surface of the electrode and the upper surface of the ABX₃ type ferroelectric thin film 11 is 0.6 μm.

FIG. 17B shows the simulation results of the electric field efficiency VπL when the gap G between the signal electrode 30 and the ground electrodes 31a and 31b is changed. The simulation results were substantially the same as those of Example 8 in which the cladding layer 16 was SiO₂, so that the smaller the gap G, the smaller the electric field efficiency VπL became; when the gap G was 4 μm, the electric field efficiency VπL was 0.53 Vcm.

### DESCRIPTION OF REFERENCES

1 Optical waveguide medium
2, 3 Optical modulation elements
10 Substrate
11 ABX₃ type ferroelectric thin film
12 First dielectric thin film
13, 13a, 13b Second dielectric thin film
14 Third dielectric thin film
15 Electrode layer
16 Cladding layer
20 Mach-Zehnder optical waveguide
20a First optical waveguide
20b Second optical waveguide
20c Splitter portion
20d Combiner portion section
20i Input optical waveguide
20o Output optical waveguide
30 Signal electrode
31, 31a, 31b Ground electrode

What is claimed is:

1. An optical waveguide medium comprising:
a substrate;
an ABX₃ type ferroelectric thin film formed on the substrate;
a first dielectric thin film formed on the ABX₃ type ferroelectric thin film;
a second dielectric thin film formed on the first dielectric thin film; and
a third dielectric thin film formed on the first and second dielectric thin films,
wherein the first, second and third dielectric thin films form a buried optical waveguide structure in which the second dielectric thin film is buried with the first and third dielectric thin films, and
the refractive indexes of the first and third dielectric thin films are lower than the refractive indexes of the ABX₃ type ferroelectric thin film and the second dielectric thin film.

2. The optical waveguide medium according to claim 1, in which the ABX₃ type ferroelectric thin film is a lithium niobate film or a lithium tantalate film.

3. The optical waveguide medium according to claim 2, in which the ABX₃ type ferroelectric thin film is a sputtered thin film.

4. The optical waveguide medium according to claim 3, wherein the substrate is a sapphire single crystal substrate.

5. The optical waveguide medium according to claim 1, wherein the first dielectric thin film and/or the third dielectric thin film is made of silicon dioxide or aluminum oxide.

6. The optical waveguide medium according to claim 1, wherein the second dielectric thin film is made of silicon nitride.

7. An optical modulation element comprising:
a substrate;
an ABX₃ type ferroelectric thin film formed on the substrate;
a first dielectric thin film formed on the ABX₃ type ferroelectric thin film;
a second dielectric thin film formed on the first dielectric thin film;
a third dielectric thin film formed on the first and second dielectric thin films; and
a traveling wave electrode formed on the third dielectric thin film and consisting of a signal electrode and a ground electrode for applying an electric field to the ABX₃ type ferroelectric thin film,
wherein the first dielectric thin film, the second dielectric thin film, and the third dielectric thin film embed the second dielectric thin film with the first dielectric thin film and the third dielectric thin film to form first and second embedded optical waveguide structures adjacent to each other, and
the refractive indexes of the first dielectric thin film and the third dielectric thin film are lower than the refractive indexes of the ABX₃ type ferroelectric thin film and the second dielectric thin film.

8. The optical modulation element according to claim 7, wherein the ABX₃ type ferroelectric thin film is a lithium niobate film or a lithium tantalate film.

9. The optical modulation element according to claim 8, wherein the ABX₃ type ferroelectric thin film is a c-axis oriented or a-axis oriented lithium niobate film.

10. The optical modulation element according to claim 8, wherein the ABX₃ type ferroelectric thin film is a sputtered thin film.

11. The optical modulation element according to claim 8, wherein the substrate is a sapphire single crystal substrate.

12. The optical modulation element according to claim 7, wherein the first dielectric thin film and the third dielectric thin film are made of silicon dioxide.

13. The optical modulation element according to claim 12, wherein the thickness of the second dielectric thin film is 0.15 μm and the width of the second dielectric thin film is 1.2 μm.

14. The optical modulation element according to claim 12, wherein the distance between the lower surface of the traveling wave electrode and the upper surface of the ABX₃ type ferroelectric thin film is 0.6 μm.

15. The optical modulation element according to claim 7, wherein the first dielectric thin film and the third dielectric thin film are made of aluminum oxide.

16. The optical modulation element according to claim 15, wherein the thickness of the second dielectric thin film is 0.15 μm and the width of the second dielectric thin film is 2.0 μm.

17. The optical modulation element according to claim 15, wherein the thickness of the first dielectric thin film is 80 nm or less.

18. The optical modulation element according to claim 7, wherein the first dielectric thin film is made of silicon dioxide and the third dielectric thin film is made of aluminum oxide.

19. The optical modulation element according to claim 7, wherein the second dielectric thin film is made of silicon nitride.

20. A method for manufacturing an optical modulation element, comprising:
a step of forming an ABX₃ type ferroelectric thin film on a substrate by a sputtering method;
a step of forming a first dielectric thin film on the ABX₃ type ferroelectric thin film;
a step of forming a second dielectric thin film on the first dielectric thin film;
a step of forming a third dielectric thin film on the first and second dielectric thin films; and
a step of forming a traveling wave electrode consisting of a signal electrode and a ground electrode on the third dielectric thin film for applying an electric field to the ABX₃ type ferroelectric thin film,
wherein the first dielectric thin film, the second dielectric thin film, and the third dielectric thin film embed the second dielectric thin film with the first dielectric thin film and the third dielectric thin film to form first and second embedded optical waveguide structures adjacent to each other, and the refractive indexes of the first dielectric thin film and the third dielectric thin film are lower than the refractive indexes of the ABX₃ type ferroelectric thin film and the second dielectric thin film.
